(19) United States
(12) Patent Application Publication
(10) Pub. No.: US 2025/0163676 A1
(43) Pub. Date: May 22, 2025

(54) TRACK LOADER

(71) Applicant: Hyundai Doosan Infracore Co., Ltd., Incheon (KR)

(72) Inventors: Cheol Rae JEONG, Incheon (KR); Chang Sung NAM, Seoul (KR)

(21) Appl. No.: 18/952,967

(22) Filed: Nov. 19, 2024

(30) Foreign Application Priority Data
Nov. 20, 2023 (KR) 10-2023-0161093

(51) Int. Cl. E02F 9/08; E02F 3/34; E02F 9/02

(52) U.S. Cl. CPC E02F 9/0808; E02F 9/024; E02F 3/3414

(57) ABSTRACT

The present disclosure relates to a track loader and may include a carriage on which a driving source and a lift arm that moves a bucket by receiving power from the driving source, an undercarriage for transporting the carriage, a suspension for buffering between the carriage and the undercarriage, and a bracket for mounting the suspension on the undercarriage, wherein the suspension includes a tube fixed to the carriage, a bar inserted into the tube, an elastic member interposed between the tube and the bar, a torsion arm connected to the bar, and an axle connected to the torsion arm, and since the axle is mounted on the bracket, it is possible to reduce an impact transferred from the undercarriage to the carriage while preventing sagging of a track.

### CROSS REFERENCE TO RELATED APPLICATION

The present application claims priority to Korean Patent Application No. 10-2023-0161093, filed Nov. 20, 2023, the entire contents of which is incorporated herein for all purposes by this reference.

### BACKGROUND OF THE INVENTION

### Field of the Invention

The present disclosure relates to a track loader, and more specifically, to a track loader capable of reducing an impact transferred from an undercarriage to a carriage while preventing sagging of a track.

### Description of the Related Art

In general, track loaders are equipment that uses a bucket to perform drilling the ground, filling the ground, leveling the ground, transporting and loading of soil or gravel and are used in architecture, construction, civil engineering, aggregate mining, and the like.

These track loaders include a carriage on which a driving source and a lift arm that moves a bucket by receiving power from the driving source are mounted, an undercarriage for transporting the carriage, and a suspension for buffering between the carriage and the undercarriage.

Here, the undercarriage includes side frames provided at side portions of the carriage, a yoke which is accommodated in the side frames and reciprocates, a sprocket mounted on the side frames and rotated by receiving power from the driving source, a roller mounted rotatably on the side frames, an idler rotatably mounted on the yoke, and a track surrounding the sprocket, the roller, and the idler.

In addition, the suspension is formed as a so-called torsion axle assembly including a tube fixed to the carriage, a bar inserted into the tube, an elastic member interposed between the tube and the bar, a torsion arm connected to the bar, and an axle connected to the torsion arm and mounted on an upper surface of the side frame.

The track loader according to such a configuration travels as the sprocket is rotated by receiving power from the driving source, the track is rotated by the sprocket, and the roller is rotated by the track.

In this process, an impact transferred from the undercarriage to the carriage is reduced by the suspension, thereby reducing a driver's fatigue.

In addition, the yoke reciprocates with respect to the side frame, and the track's tension is controlled by the idler, thereby preventing sagging of the track.

However, such a conventional track loader has a problem that, as the suspension presses the upper surface of the side frame, the yoke is pressed by an upper plate of the side frame to interfere with the movement, and the sagging of the track cannot be smoothly prevented through the yoke and the idler.

### Document of Related Art

### Patent Document

U.S. Pat. No. 8,573,336 B2

### SUMMARY OF THE INVENTION

Therefore, the present disclosure relates to a track loader capable of reducing an impact transferred from an undercarriage to a carriage while preventing sagging of a track.

To achieve the above object, the present disclosure provides a track loader including a carriage on which a driving source and a lift arm that moves a bucket by receiving power from the driving source, an undercarriage formed to transport the carriage, a suspension formed to buffer between the carriage and the undercarriage, and brackets formed to mount the suspension on the undercarriage, wherein the suspension includes a tube fixed to the carriage, a bar inserted into the tube, an elastic member interposed between the tube and the bar, a torsion arm connected to the bar, and an axle connected to the torsion arm, and the axle is mounted on the brackets.

The undercarriage may include side frames provided at side portions of the carriage, a yoke that is accommodated in the side frames and reciprocates, a sprocket mounted on the side frames and rotated by receiving power from the driving source, a roller rotatably mounted on the side frames, an idler rotatably mounted on the yoke, and a track surrounding the sprocket, the roller, and the idler, the side frames include side frame upper plates facing an upper surface of the yoke, and side frame side plates bent from the side frame side plates and facing a side surface of the yoke, and the brackets are supported by the side frame side plates.

The brackets may include bracket upper portions supporting the axle, and bracket side portions supported by the side frame side plates and supporting the bracket upper portions.

The bracket upper portions may be spaced apart from the side frame upper plates in a direction opposite to gravity.
The bracket side portions may be welded to the side frame side plates.

The side frame side plate may include a slit cut in a reciprocating direction of the yoke under the yoke, and further includes a plate having a slit insertion portion inserted into the slit, a yoke support extending from the slit insertion portion to the inside of the side frame and supporting a lower surface of the yoke, and a bracket support extending from the slit insertion portion to the outside of the side frame and supporting the bracket side portion.

The bracket support may be welded to the bracket side portion.

The bracket side portion may include a bracket side portion front surface in contact with the bracket support, a bracket side portion inner surface in contact with the side frame side plate, a bracket side portion outer surface forming a rear surface of the bracket side portion inner surface, and a bracket side portion outer chamfer surface formed by cutting a corner between the bracket side portion front surface and the bracket side portion outer surface, and a welding bead generated when the bracket side portion and the bracket support are welded is accommodated in a space between the bracket side portion outer chamfer surface and the bracket support.

The bracket support 286 may be welded to the side frame side plates 214.

The bracket side portion may include a bracket side portion front surface in contact with the bracket support, a bracket side portion inner surface in contact with the side frame side plate, and a bracket side portion inner chamfer surface formed by cutting a corner between the bracket side portion front surface and the bracket side portion inner surface, and a portion of a welding bead generated when the bracket side portion and the side frame side plate are welded is accommodated in a space between the bracket side portion inner chamfer surface and the side frame side plate.

The bracket may include a first bracket and a second bracket spaced apart from each other in the reciprocating direction of the yoke, and a length of the first bracket and a length of the second bracket are each formed smaller than a length of the bracket support in the reciprocating direction of the yoke. The bracket may further includes a rib extending from the first bracket to the second bracket.

The rib may extend from a first bracket side portion, which is the bracket side portion of the first bracket, to a second bracket side portion, which is the bracket side portion of the second bracket.

In the direction of gravity, a length of the rib may be formed smaller than the length of the first bracket side portion and the length of the second bracket side portion.

The side frame side plate may include a first portion connected to the side frame upper plate and a second portion extending to protrude more than the side frame upper plate from the first portion to the idler, and the bracket is seated on the second portion.

The bracket upper portion may face the upper surface of the yoke.

A distance between the bracket upper portion and the yoke is greater than a distance between the side frame upper plate and the upper surface of the yoke.

The bracket may further include a bracket lower portion facing the bracket upper portion and supporting the lower surface of the yoke.

In addition, the present disclosure provides a track loader including a carriage on which a lift arm is mounted, an undercarriage including a side frame including a side frame side portion and a side frame side plate, a suspension formed to buffer between the carriage and the undercarriage, and a bracket formed to mount the suspension on the side frame, wherein the bracket is supported by the side frame side plate and spaced apart from the side frame upper plate in a direction opposite to gravity, and the side frame side plate includes a cut slit, and further includes a plate having a bracket support inserted into the slit and supporting the bracket.

The side frame may be formed by cutting the side frame upper plate and the side frame side plate that are connected to one steel plate, cutting the slit at the side frame side plate side, and then bending the side plate at the side upper plate.

### BRIEF DESCRIPTION OF THE DRAWINGS

FIG. 1 is a perspective view showing a track loader according to one embodiment of the present disclosure.

FIG. 2 is a perspective view showing a suspension in the track loader of FIG. 1.

FIG. 3 is a cross-sectional view along line A-A in FIG. 2.

FIG. 4 is a perspective view showing a state in which the suspension of FIG. 2 is mounted.

FIG. 5 is a perspective view showing a side frame, a bracket, and a plate in FIG. 4.

FIG. 6 is an exploded perspective view of FIG. 5.

FIG. 7 is a front view of FIG. 5.

FIG. 8 is a partial enlarged view of portion B in FIG. 7.

FIG. 9 is an exploded perspective view showing a side frame and a bracket in a track loader according to another embodiment of the present disclosure.

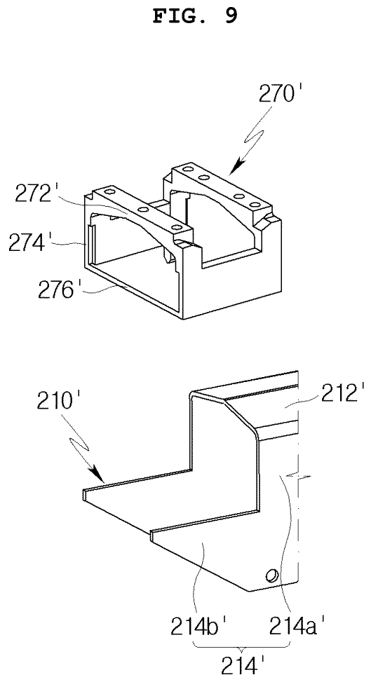

### DETAILED DESCRIPTION OF THE INVENTION

Hereinafter, a track loader according to the present disclosure will be described in detail with reference to the accompanying drawings.

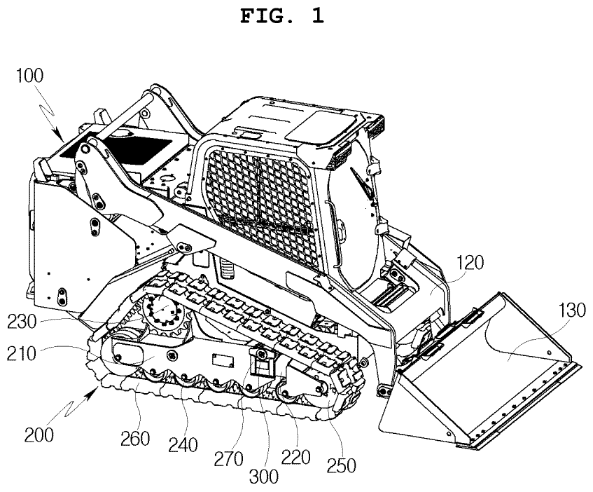

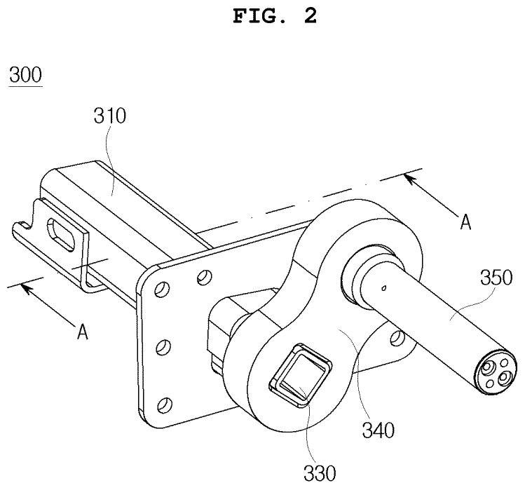

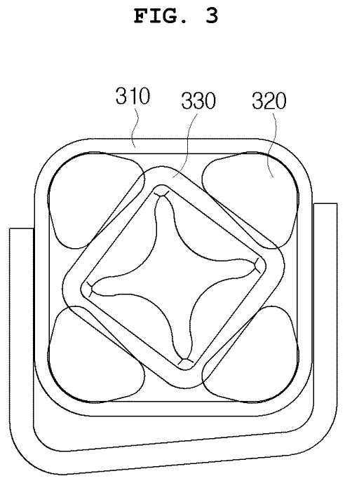

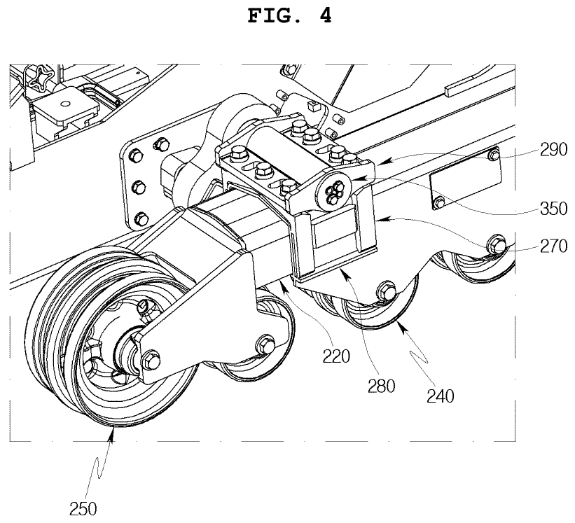

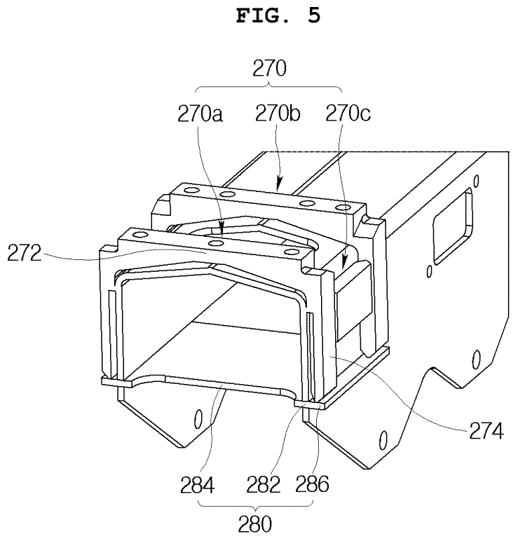

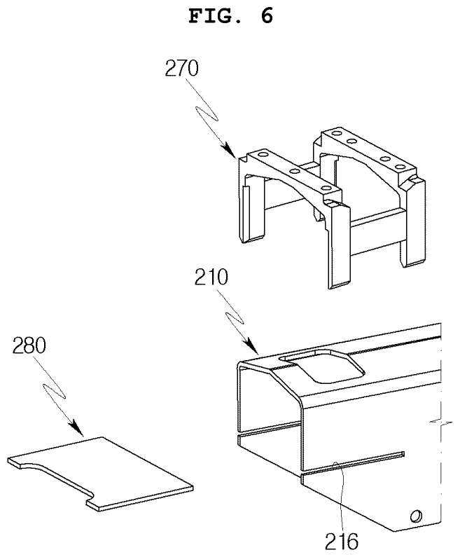

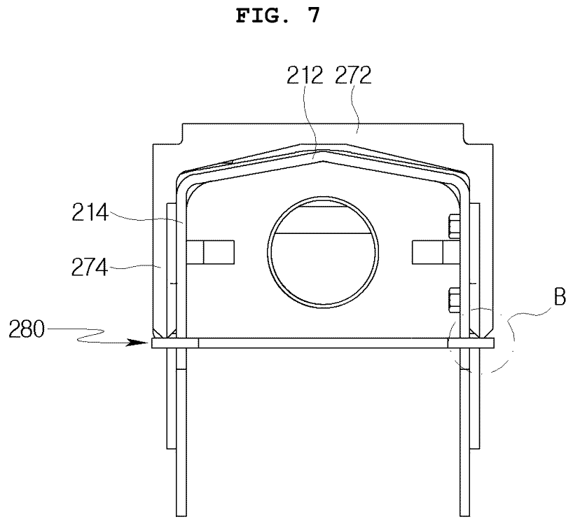

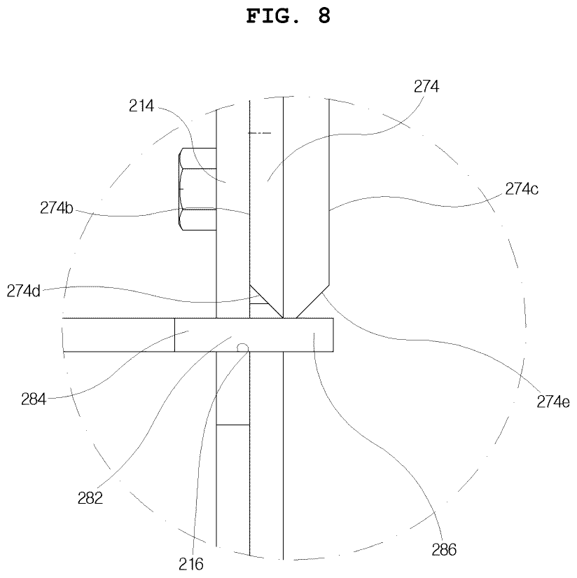

FIG. 1 is a perspective view showing a track loader according to one embodiment of the present disclosure, FIG. 2 is a perspective view showing a suspension in the track loader of FIG. 1, FIG. 3 is a cross-sectional view along line A-A in FIG. 2, FIG. 4 is a perspective view showing a state in which the suspension of FIG. 2 is mounted, FIG. 5 is a perspective view showing a side frame, a bracket, and a plate in FIG. 4, FIG. 6 is an exploded perspective view of FIG. 5, FIG. 7 is a front view of FIG. 5, and FIG. 8 is a partial enlarged view of portion B in FIG. 7.

As shown in these drawings, the track loader according to one embodiment of the present disclosure may include a carriage 100 on which a driving source and a lift arm 120 that moves a bucket 130 by receiving power from the driving source, an undercarriage 200 for transporting the carriage 100, and a suspension 300 for buffering between the carriage 100 and the undercarriage 200.

The undercarriage 200 may include a side frame 210 provided at a side portion of the carriage 100, a yoke 220 that is accommodated in the side frame 210 and reciprocates, a sprocket 230 mounted on the side frame 210 and rotated by receiving power from the driving source, a roller 240 rotatably mounted on the side frame 210, an idler 250 rotatably mounted on the yoke 220, and a track 260 surrounding the sprocket 230, the roller 240, and the idler 250.

The suspension 300 may be formed as a so-called torsion axle assembly including a tube 310 fixed to the carriage 100, a bar 330 inserted into the tube 310, an elastic member 320 interposed between the tube 310 and the bar 330, a torsion arm 340 connected to the bar 330, and an axle 350 connected to the torsion arm 340.

Here, the track loader according to the present embodiment may further include a bracket 270 for mounting the suspension 300 on the undercarriage 200.

Specifically, the side frame 210 includes a side frame upper plate 212 facing an upper surface of the yoke 220 and side frame side plates 214 bent from the side frame upper plate 212 and facing side surfaces of the yoke 220, and the yoke 220 may be accommodated in a space formed by the side frame upper plate 212 and the side frame side plates 214.

In addition, the bracket 270 may include a first bracket 270a and a second bracket 270b spaced apart from each other in a reciprocating direction of the yoke 220, and the first bracket 270a and the second bracket 270b may each include a bracket upper portion 272 supporting the axle 350 and bracket side portions 274 supported by the side frame side plates 214 and supporting the bracket upper portion 272.

The bracket upper portion 272 may be formed to be spaced apart from the side frame upper plate 212 in a direction opposite to gravity, and the bracket side portions 274 may be welded to the side frame side plates 214 and directly supported by the side frame side plates 214.

In addition, the side frame side plate 214 may include a slit 216 cut under the yoke 220 in the reciprocating direction of the yoke 220, a plate 280 inserted into the slit 216 may be provided, and the plate 280 may support the bracket side portions 274, and thus the bracket side portions 274 may be indirectly supported by the side frame side portions 214.

Here, the plate 280 may support the yoke 220 as well as the bracket side portions 274. That is, the plate 280 may include a slit insertion portion 282 inserted into the slit 216, a yoke support 284 extending from the slit insertion portion 282 to the inside of the side frame 210, and a bracket support 286 extending from the slit insertion portion 282 to the outside of the side frame 210, and the yoke support 284 may support a lower surface of the yoke 220, and the bracket support 286 may support the bracket side portion 274.

Meanwhile, the bracket support 286 may be welded to the bracket side portion 274 so that the plate 280 is prevented from being separated from the slit 216 and the bracket side portion 274 is stably supported by the plate 280.

Here, the bracket side portion 274 may include a bracket side portion front surface 274a in contact with the bracket support 286, a bracket side portion inner surface 274b in contact with the side frame side plate 214, a bracket side portion outer surface 274c forming a rear surface of the bracket side portion inner surface 274b, and a bracket side portion outer chamfer surface 274e formed by cutting a corner between the bracket side portion front surface 274a and the bracket side portion outer surface 274c, and a first welding bead generated when the bracket side portion 274 and the bracket support 286 are welded may be accommodated in a space between the bracket side portion outer chamfer surface 274e and the bracket support 286. In this case, the first welding bead may not protrude outward more than the bracket side portion outer surface 274c, and thus a length of the plate 280 in the extending direction (left-right direction in FIG. 8) that needs to accommodate the first welding bead can be reduced.

In addition, the bracket support 286 (particularly, a portion of the bracket support 286 not in contact with the bracket side portion 274) may be welded to the side frame side plate 214 so that the plate 280 is more reliably prevented from being separated from the slit 216.

Here, the bracket side portion 274 may include a bracket side portion inner chamfer surface 274d formed by cutting a corner between the bracket side front end surface 274a and the bracket side portion inner surface 274b, and a portion of a second welding bead generated when the bracket support 286 and the side frame side plate 214 are welded may be accommodated in a space between the bracket side portion inner chamfer surface 274d, the bracket support 286, and the side frame side plate 214. In this case, the second welding bead can be prevented from overflowing, and coupling strength between the bracket side portion 274, the bracket support 286, and the side frame side plate 214 can be increased by the second welding bead flowing into a space between the bracket side portion 274, the bracket support 286, and the side frame side plate 214.

Meanwhile, the track loader may further include a cover 290 fastened to the bracket upper portion 272 at a side opposite to the bracket 270 with respect to the axle 350 to prevent separation of the axle 350.

Hereinafter, the operational effect of the track loader according to the present embodiment will be described.

That is, the track loader may travel on the ground as the sprocket 230 is rotated by receiving power from the driving source, the track 260 is rotated by the sprocket 230, and the roller 240 is rotated by the track 260.

In addition, the track loader may perform drilling the ground, filling the ground, leveling the ground, and the like as the lift arm 120 and the bucket 130 are operated by receiving power from the driving source.

In this process, an impact transmitted from the undercarriage 200 to the carriage 100 can be reduced by the suspension 300, thereby reducing the driver's fatigue.

In addition, the yoke 220 may reciprocate with respect to the side frame 210 and control the tension of the track 260 using the idler above (250), thereby preventing sagging of the track 260.

Here, in the track loader according to the present embodiment, as the axle 350 of the suspension 300 is mounted on the bracket 270 supported by the side frame side plate 214, the side frame upper plate 212 can be prevented from being pressed by the axle 350 and bent toward the yoke 220. Therefore, the yoke 220 can be prevented from being pressed by the side frame upper plate 212, thereby preventing the movement of the yoke 220 from interfering with the side frame upper plate 212, and the sagging of the track 260 can be smoothly prevented by the yoke 220 and the idler 250.

In particular, the bracket 270 may include the bracket upper portion 272 supporting the axle 350 and the bracket side portions 274 supported by the side frame side plates 214 and supporting the bracket upper portion 272, and as the bracket upper portion 272 is spaced apart from the side frame upper plate 212 in the direction opposite to gravity, the side frame upper plate 212 can be effectively prevented from being bent toward the yoke 220.

In addition, since the bracket side portion 274 is not only directly supported by the side frame side plate 214, but also indirectly supported by the side frame side plate 214 through the plate 280, the bracket 270 can be stably supported by the side frame side plate 214.

Meanwhile, in the present embodiment, the bracket 270 may include the first bracket 270a and the second bracket 270b spaced apart from each other in the reciprocating direction of the yoke 220, and a length of the first bracket 270a and a length of the second bracket 270b may each be smaller than half of a length of the bracket support 286 in the reciprocating direction of the yoke 220. In this case, a rib 270c extending from the first bracket 270a to the second bracket 270b may be provided to maintain a distance between the first bracket 270a and the second bracket 270b and secure the overall stiffness of the bracket 270. The rib 270c may be formed at any position, but may preferably extend from the first bracket side portion, which is the bracket side portion 274 of the first bracket 270a, to the second bracket side portion 274 of the second bracket 270b, so as not to interfere with the axle 350 and to stably support the first bracket 270a and the second bracket 270b. In addition, to minimize an increase in weight due to the rib 270c, a length of the rib 270c may be preferably formed smaller than a length of the first bracket side portion and a length of the second bracket side portion.

However, the present disclosure is not limited thereto, and the bracket 270 may be formed as a single product for cost saving and the like. That is, instead of including the first bracket 270a, the second bracket 270b, and the rib 270c, the bracket 270 may be formed as a single bracket having a length equal to the length of the bracket support 286 in the reciprocating direction of the yoke 220.

Meanwhile, in the present embodiment, the side frame 210, the plate 280, and the bracket 270 may be formed according to the following manufacturing method in consideration of ease of manufacturing. That is, the side frame 210 may be formed by cutting the side frame upper plate 212 and the side frame side plate 214 that are connected to one steel plate, further cutting the slit 216 at the side frame side plate 214, and then bending the side plate at the side upper plate. In addition, each of the frame and the bracket 270 may be separately formed. In addition, the bracket 270 may be inserted into the slit 216 of the side frame 210, and the bracket 270 may be seated on the side frame 210 and the plate 280. In addition, the side frame 210, the plate 280, and the bracket 270 may be welded.

However, the present disclosure is not limited thereto, and to further reduce the cost, a bracket 270′ may be formed by canning or casting, then seated on a side frame 210′, and welded.

Specifically, a side frame side plate 214′ may include a first portion 214a′ connected to a side frame upper plate 212′ and a second portion 214b′ extending to protrude more than the side frame upper plate 212′ from the first portion 214a′ to the idler 250.

In addition, the bracket 270′ may include a bracket upper portion 272′ formed by canning or casting to support the axle 350, a bracket side portion 274′ bent from the bracket upper portion 272′ and supported by the side frame side plate 214′, and a bracket lower portion 276′ bent from the bracket side portion 274′, facing the bracket upper portion 272′, and supporting the lower surface of the yoke 220.

In addition, the bracket 270′ may be welded after being seated on the second portion 214b′ of the side frame side plate 214′. Specifically, a lower surface of the bracket side portion 274′ may be seated on an upper surface of the second portion 214b′ of the side frame side plate 214′, one side surface of the bracket side portion 274′ may be seated on a side surface of the second portion 214b′ of the first portion 214a′ of the side frame side plate 214′, the lower surface of the bracket side portion 274′ and the upper surface of the second portion 214b′ of the side frame side plate 214′ may be welded, and the one side surface of the bracket side portion 274′ and the side surface of the second portion 214b′ of the first portion 214a′ of the side frame side plate 214′ may be welded.

In this case, costs required for forming the bracket 270′ and fastening the bracket 270′ to the side frame 210′ can be significantly reduced using the canning or casting method.

In addition, since it is not necessary to separately form the plate 280 and the slit 216 of the above-described embodiment, it is possible to further save the costs.

Meanwhile, in this case, as the bracket upper portion 272′ directly faces the upper surface of the yoke 220, that is, as the side frame upper plate 212′ is not present between the yoke 220 and the bracket upper portion 272′, it is possible to prevent the side frame upper plate 212′ from being pressed by the bracket upper portion 272′ to press the yoke 220.

In addition, in the direction of gravity, since a distance between the bracket upper portion 272′ and the upper surface of the yoke 220 is formed greater than a distance between the side frame upper plate 212′ and the upper surface of the yoke 220, even when the bracket upper portion 272′ is deformed, it is possible to suppress the yoke 220 from being pressed by the bracket upper portion 272′.

The track loader according to the present disclosure includes a carriage on which a driving source and a lift arm that moves a bucket by receiving power from the driving source, an undercarriage for transporting the carriage, a suspension for buffering between the carriage and the undercarriage, and a bracket for mounting the suspension on the undercarriage, wherein the suspension includes a tube fixed to the carriage, a bar inserted into the tube, an elastic member interposed between the tube and the bar, a torsion arm connected to the bar, and an axle connected to the torsion arm, and since the axle is mounted on the bracket, it is possible to reduce an impact transferred from the undercarriage to the carriage while preventing sagging of a track.

### DESCRIPTION OF REFERENCE NUMERALS

100: carriage
120: lift arm
130: bucket
200: undercarriage
210, 210′: side frames
212, 212′: side frame upper plates
214, 214′: side frame side plates
214a′: first portion
214b′: second portion
216: slit
220: yoke
230: sprocket
240: roller
250: idler
260: track
270, 270′: brackets
270a: first bracket
270b: second bracket
270c: rib
272, 272′: bracket upper portions
274, 274′: bracket side portions
274a: bracket side portion front surface
274b: bracket side portion inner surface
274c: bracket side portion outer surface
274d: bracket side portion inner chamfer surface
274e: bracket side portion inner chamfer surface
276′: bracket lower portion
280: plate
282: slit insertion portion
284: yoke support
286: bracket support
290: cover
300: suspension
310: tube
320: elastic member
330: bar
340: torsion arm
350: axle

What is claimed is:

1. A track loader comprising:
a carriage on which a driving source and a lift arm that moves a bucket by receiving power from the driving source;
an undercarriage formed to transport the carriage;
a suspension formed to buffer between the carriage and the undercarriage; and
brackets formed to mount the suspension on the undercarriage,
wherein the suspension includes a tube fixed to the carriage, a bar inserted into the tube, an elastic member interposed between the tube and the bar, a torsion arm connected to the bar, and an axle connected to the torsion arm, and
the axle is mounted on the brackets.

2. The track loader of claim 1, wherein the undercarriage includes side frames provided at side portions of the carriage, a yoke that is accommodated in the side frames and reciprocates, a sprocket mounted on the side frames and rotated by receiving power from the driving source, a roller rotatably mounted on the side frames, an idler rotatably mounted on the yoke, and a track surrounding the sprocket, the roller, and the idler,
the side frames include side frame upper plates facing an upper surface of the yoke, and side frame side plates bent from the side frame side plates and facing a side surface of the yoke, and
the brackets are supported by the side frame side plates.

3. The track loader of claim 2, wherein the brackets include bracket upper portions supporting the axle, and bracket side portions supported by the side frame side plates and supporting the bracket upper portions.

4. The track loader of claim 3, wherein the bracket upper portions are spaced apart from the side frame upper plates in a direction opposite to gravity.

5. The track loader of claim 3, wherein the bracket side portions are welded to the side frame side plates.

6. The track loader of claim 3, wherein the side frame side plate includes a slit cut in a reciprocating direction of the yoke under the yoke, and
further includes a plate having a slit insertion portion inserted into the slit, a yoke support extending from the slit insertion portion to the inside of the side frame and supporting a lower surface of the yoke, and a bracket support extending from the slit insertion portion to the outside of the side frame and supporting the bracket side portion.

7. The track loader of claim 6, wherein the bracket support is welded to the bracket side portion.

8. The track loader of claim 7, wherein the bracket side portion includes a bracket side portion front surface in contact with the bracket support, a bracket side portion inner surface in contact with the side frame side plate, a bracket side portion outer surface forming a rear surface of the bracket side portion inner surface, and a bracket side portion outer chamfer surface formed by cutting a corner between the bracket side portion front surface and the bracket side portion outer surface, and
a welding bead generated when the bracket side portion and the bracket support are welded is accommodated in a space between the bracket side portion outer chamfer surface and the bracket support.

9. The track loader of claim 6, wherein the bracket support is welded to the side frame side plates.

10. The track loader of claim 9, wherein the bracket side portion includes a bracket side portion front surface in contact with the bracket support, a bracket side portion inner surface in contact with the side frame side plate, and a bracket side portion inner chamfer surface formed by cutting a corner between the bracket side portion front surface and the bracket side portion inner surface, and
a portion of a welding bead generated when the bracket side portion and the side frame side plate are welded is accommodated in a space between the bracket side portion inner chamfer surface and the side frame side plate.

11. The track loader of claim 6, wherein the bracket includes a first bracket and a second bracket spaced apart from each other in the reciprocating direction of the yoke, and
a length of the first bracket and a length of the second bracket are each formed smaller than a length of the bracket support in the reciprocating direction of the yoke.

12. The track loader of claim 11, wherein the bracket further includes a rib extending from the first bracket to the second bracket.

13. The track loader of claim 12, wherein the rib extends from a first bracket side portion, which is the bracket side portion of the first bracket, to a second bracket side portion, which is the bracket side portion of the second bracket.

14. The track loader of claim 13, wherein in the direction of gravity, a length of the rib is formed smaller than the length of the first bracket side portion and the length of the second bracket side portion.

15. The track loader of claim 3, wherein the side frame side plate includes a first portion connected to the side frame upper plate and a second portion extending to protrude more than the side frame upper plate from the first portion to the idler, and
the bracket is seated on the second portion.

16. The track loader of claim 15, wherein the bracket upper portion faces the upper surface of the yoke.

17. The track loader of claim 16, wherein a distance between the bracket upper portion and the yoke is greater than a distance between the side frame upper plate and the upper surface of the yoke.

18. The track loader of claim 15, wherein the bracket further includes a bracket lower portion facing the bracket upper portion and supporting the lower surface of the yoke.

19. A track loader comprising:
a carriage on which a lift arm is mounted;
an undercarriage including a side frame including a side frame upper plate and a side frame side plate;
a suspension formed to buffer between the carriage and the undercarriage; and
a bracket formed to mount the suspension on the side frame,
wherein the bracket is supported by the side frame side plate and spaced apart from the side frame upper plate in a direction opposite to gravity, and
the side frame side plate includes a cut slit, and
further includes a plate having a bracket support inserted into the slit and supporting the bracket.

20. The track loader of claim 19, wherein the side frame is formed by cutting the side frame upper plate and the side frame side plate that are connected to one steel plate, cutting the slit at the side frame side plate side, and then bending the side plate at the side upper plate.
